(19) United States
(12) Patent Application Publication
(10) Pub. No.: US 2009/0291673 A1
(43) Pub. Date: Nov. 26, 2009

(54) Method for Connecting a Cellular Mobile Terminal To a Hot Line Involving Locating the Terminal

(76) Inventors: Franck Chauvigne, Thenilles (FR); Cécile Bonnardot, Paris (FR); Thibaut Keraval, Linas (FR); David Rouxel, Versailles (FR)

Correspondence Address: Blakely, Sokoloff, Taylor & Zafman LLP, 1279 Oakmead Parkway, Sunnyvale, CA, 94085-4040, US

(21) Appl. No.: 12/083,647

(22) PCT Filed: Oct. 13, 2006
(86) PCT No.: PCT/EP2006/067386

§ 371 Date: Apr. 14, 2008

(30) Foreign Application Priority Data
Oct. 13, 2005 (FR) 0510443

(51) Int. Cl. H04L 29/06

(52) U.S. Cl. 455/414.3

(57) ABSTRACT

The invention concerns a method for connecting a cellular mobile terminal (10) to a server (21, 22, 23) to deliver a hot line involving locating the terminal (10). The invention is characterized in that it includes the following steps: the mobile terminal (10) transmits to the server (21, 22, 23) delivering the hot lint, a request for connection (1) to the hot line; the mobile terminal (10) also transmits to the server (21) a useful information (4) for the server (21, 22, 23) delivering the hot line so as to transmit to the mobile terminal (10) a content corresponding to the connection request, the useful information (4) being determined based on a locating information contained in the mobile terminal (10).

This is a non-provisional application claiming the benefit of International application number PCT/EP2006/067386 filed Oct. 13, 2006.

The invention relates to the field of mobile telephony.

In particular, it relates to the assistance services offered to the users of mobile phones, where these assistance services necessitate location of the mobile phone.

For example, these assistance services allow a user to obtain information (itineraries, the nearest restaurants, cinemas, sports centres, etc.) concerning the geographical zone in which it is located.

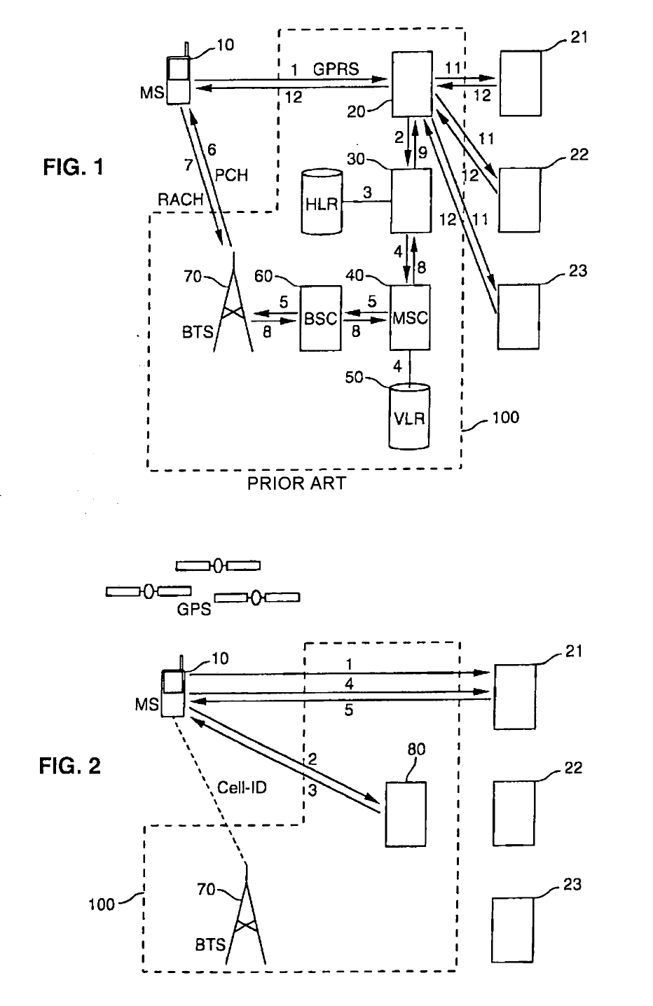

As illustrated in FIG. 1, when a user employs his mobile phone MS 10 in order to connect to an assistance service (an i-Mode™ service, for example) via the mobile telephony network 100, the mobile terminal 10 transmits a connection request (1) to an access gateway 20. The access gateway 20 (an i-Mode™ server, for example) then triggers a procedure for location of the mobile phone.

To this end, the access gateway 20 transmits a mobile phone location request (2) to a location platform 30 in the mobile telephony network. The location platform 30 then triggers a process for location of the mobile phone 10 that is similar to the search process (paging) that is performed during the routing of a call to the mobile phone.

The location platform 30 interrogates (3) the Home Location Register (HLR). The HLR contains the last number of the Visitor Location Register (VLR) to which the mobile phone 10 has indicated itself.

The location platform 30 transmits (4) to the VLR, the International Mobile Subscriber Identity (IMSI) of the subscriber of the mobile phone to be located.

The Mobile Services Switching Centre (MSC) 40 associates with the VLR 50 command (5) a plurality of Base Station Controllers (BSC) 60 and Base Transceiver Stations (BTS) of the location area (LA) in which the user is located, so that the base stations BTS 70 emit a user paging signal (6) on a Paging Channel (PCH). The paging signal contains the IMSI of the mobile phone to be located.

In response to the paging signal (6), the mobile phone 10 transmits a signal (7) to the closest base stations BTS 70 on the digital signalling channel or Random Access Channel (RACH). The response signal (7) emitted by the mobile phone 10 contains information identifying the phone.

The base station BTS 70 transfers the response of the mobile phone to the BSC 60 with which it is associated, and the BSC 60 transmits (8) to the location platform 30 the references of the cell (Cell-id) in which the mobile phone 10 is located.

The location platform 30 converts the references of the cell into the geographical position coordinates of the mobile phone, and transmits (9) the geographical position coordinates to the access gateway 20. If the user of the mobile phone 10 agrees to communicate its position, the gateway 20 transmits (11) the geographical coordinates to the concerned service provider 21, 22 or 23.

The service provider 21, 22 or 23 can thus process the geographical coordinates of the mobile phone 10 and transmit (12) to the mobile phone 10, content that is appropriate to these coordinates.

One drawback of these assistance services is that access to these services is relatively lengthy and results in a wait time for the user. In particular, the location procedure by paging takes some fifteen seconds.

Furthermore, the location procedure necessitates a series of exchanges between the mobile phone and a base station on the PCH and RACH channels. As a consequence, the location procedure involves an interruption in the transmission of data packets by the GPRS channel of the mobile terminal. Navigation is therefore not a fluid process for the user.

US 2004/147268 A1, US 2003/157942 A1, GB-A-2 353 919 and WO 00/29979 A disclose methods and terminals according to the preambles of claims 1 and 11 respectively.

One aim of the invention is to reduce the time necessary to access the assistance services, necessitating the location of a mobile terminal.

To this end, the invention proposes a method for the connection of a cellular mobile terminal to a server that is intended to deliver an assistance service which necessitates location of the terminal, characterised in that it includes steps in which:
the mobile terminal transmits, to the server delivering the assistance service, a request for connection to the assistance service,
the mobile terminal also transmits, to the server, information that can be used by the server that is intended to deliver the assistance service, with a view to transmitting, to the mobile terminal, content corresponding to the connection request, with the useful information being determined as a function of location information contained in the mobile terminal.

The mobile terminal transmits, to the server of the service provider, the useful information necessary so that the server can transmit the required content to the terminal, so that it is not necessary to execute a search process for the mobile terminal by the mobile telephony network (no paging process).

Incidentally, the useful information is information that can be determined from location information that is available in the terminal.

The method of the invention is used to reduce the time necessary for the terminal to establish a connection with an assistance service.

Furthermore, the connection method of the invention does not need to interrupt the data transmissions via the data channel of the terminal.

In the connection method of the invention, the connection request contains data adapted to be identified by the server, the said data indicating to the server that the useful information will be transmitted to the server by the mobile terminal.

In an embodiment of the invention, the connection method includes steps in which:
the mobile terminal transmits, to a location server, location information that is contained in the mobile terminal,
the location server converts the location information into information that can be used by the server that is intended to deliver an assistance service, and transmits the said useful information to the mobile terminal.

In such a connection method, the location information can be information that is recorded in the mobile terminal.

In particular, the location information can be information that identifies a cell of a cellular mobile telephony network in which the mobile terminal is located.

In an embodiment of the connection method, the mobile terminal transmits, to the location server, a connection request that contains the useful information.

In an embodiment of the connection method, the useful information includes geographical position coordinates of the mobile phone.

In an embodiment of the invention, the connection method, includes steps in which:
the mobile terminal transmits the useful information to the server intended to deliver the assistance service,
the server processes the useful information and transmits, to the mobile phone, content that is dependent upon the useful information.

In an embodiment of the invention, the connection method includes a step in which:
the location server verifies that the assistance service is authorised to receive the content that is dependent upon the useful information.

In an embodiment of the connection method, the mobile terminal transmits the useful information via a data channel of the mobile terminal.

In an embodiment of the invention, the connection method, includes a preliminary step in which the mobile terminal displays, on a screen, a window that proposes, to the user, the transmission of location information of the mobile terminal, the user being able to accept or refuse the proposal, and in which the step of transmission of the useful information is executed only if the user accepts the proposal.

The invention also relates to a cellular mobile terminal according to claim 11.

Other characteristics and advantages will emerge from the description that follows, which is purely illustrative and non-limiting, and should be read with reference to the appended figures in which:

FIG. 1, already mentioned, schematically represents the different steps of a connection method to an assistance service according to the prior art,

FIG. 2 schematically represents the different steps of a connection method to an assistance service according to a first embodiment of the invention,

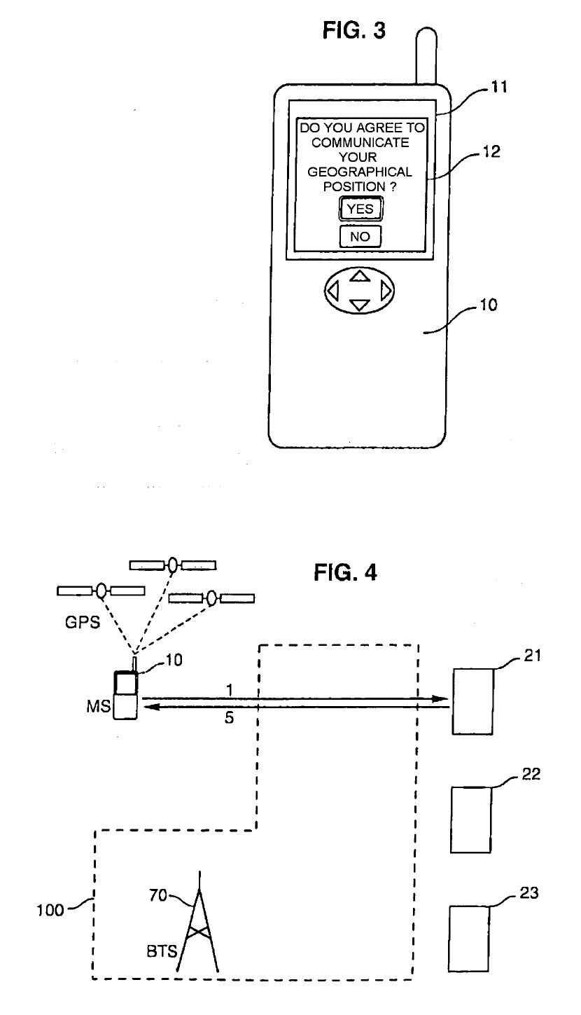

FIG. 3 schematically represents a popup window that is displayed on a screen of a mobile phone during execution of the connection method,

FIG. 4 schematically represents the different steps of a connection method to an assistance service according to a second embodiment of the invention.

As illustrated in FIG. 2, according to a first embodiment of the method of the invention, the mobile telephony network 100 is a GSM-GPRS network. The cellular mobile phone 10 is a mobile phone that is adapted to communicate with the mobile telephony network 100 by means of a GSM voice channel or a GPRS data channel. In particular, the mobile phone 10 is adapted to access i-Mode™ services.

Let us assume that the user of the cellular mobile phone 10 wishes to connect, via the mobile telephony network 100, to an i-mode service necessitating the location of the mobile phone 10. As an example, the user selects a “Nearby restaurants” proposal.

The user selects the i-Mode™ menu on his mobile phone 10. The selection of the i-Mode™ menu triggers the execution, by the browser of the mobile phone 10, of an Application Programming Interface (API) program that includes the following steps.

In a first step, the mobile phone 10 displays, on a screen 11, a window 12 (a popup window) that proposes, to the user, transmission of the geographical position of the mobile phone to one of the servers 21, 22 or 23. The servers 21, 22, 23 are servers controlled by service providers.

The window contains a message of the type: “Do you agree to communicate your geographical position?”. The user can then select either of the responses displayed, namely “YES” or “NO” (FIG. 3).

In a second step, if the user selects the “YES” proposal, the mobile phone 10 transmits a connection request 1 to one of the servers 21, 22 or 23.

The connection request 1 is a request of the http type that includes the URL address of a page contained on one of the servers 21, 22 or 23 as well as a header containing data adapted to be identified by the server 21. The data indicate to the server 21 that the position of the mobile terminal 10 will be transmitted to the server 21 by the mobile terminal 21.

After identifying these data, the server 21 does not trigger a process for location of the mobile phone 10.

In a third step, the browser of the mobile phone 10 determines the location information of the phone 10. The location information is information that identifies a cell of the cellular mobile telephony network 100 in which the mobile phone 10 is located (Cell-id information). This information is known to the mobile phone 10, and is recorded in the software layer of the mobile phone.

In a fourth step, the browser of the mobile phone 10 generates a location request 2 containing the Cell-id information. The mobile phone 10 transmits the location request 2 to a location server 80 of the network 100.

In a fifth step, the location server 80 processes the location request 2. The location server 80 determines for which server 21, 22 or 23 the Cell-id information is destined.

The fifth step is a step to check the rights of the service provider and of the user.

The location server 80 verifies that the service provider with which the server 21 is associated for example, is authorised to obtain information concerning the location of the mobile phone 10. The location server 80 also verifies that the mobile phone 10 is authorised to obtain information concerning its location.

In a sixth step, the location server 80 converts the location information contained in the request 2 into the geographical position coordinates (X, Y) of the mobile phone 10.

In a seventh step, the location server 80 transmits the geographical position coordinates (X, Y) (3) to the mobile phone 10.

In an eighth step, the mobile phone 10 transmits, to the server 21, the geographical position data (X, Y) 4 that it has received from the location server 80.

In a ninth step, the coordinates (X, Y) are processed by the server 21 in order to transmit content to the mobile phone 10 (itineraries, the nearest restaurants, cinemas, sports centres, etc.) that is dependent upon the geographical zone in which the mobile phone 10 is located.

In a tenth step, the server 21 transmits the corresponding content 5 to the mobile phone 10.

If the user a selects the “NO” response in the first step, then the mobile phone 10 directly executes an eleventh step in which the mobile phone 10 transmits a connection request 1 to one of the http servers 21, 22 or 23 that does not include a header containing the data indicating to the server 21 that the position of the mobile phone 10 will be transmitted by the mobile phone at a later step.

As a result of this eleventh step, the server 21 can trigger a conventional process for location of the mobile phone 10 which is identical to the process of the prior art (a paging process for example).

In the connection method that has just been described, it is the mobile phone 10 itself that identifies the cell of the mobile telephony network in which it is located. It is therefore not the network that supplies the useful information necessary for location of the mobile phone. This location method therefore does not involve any location platform.

Incidentally, the content providers 21, 22, 23 do not ask the network to locate the mobile phone 10.

In such a connection method, it is estimated that the third, fourth, fifth, sixth, seventh and eighth steps take about 6 or 7 seconds.

During these steps, the mobile phone 10 is connected to the location server 80. The exchanges of data between the mobile phone 10 and the location server 80 by the GPRS data channel of the mobile phone are not interrupted.

It will be noted that the location information transmitted by the mobile phone 10 to the location server 80 can be converted by the location server 80 into information that is not necessarily composed of the geographical position coordinates (X, Y) of the mobile phone 10. The location server 80 can convert the location information into an altitude for example, or into any type of useful information in order for the service provider to transmit appropriate content to the mobile phone.

Incidentally, it can also be arranged that the user should be able to configure the mobile phone 10 in two operating modes.

The user can select a first operating mode “with authorisation to locate” the mobile phone 10. In this case, the mobile phone 10 always executes the first step in which it displays, on a screen 11, the popup window 12 that proposes, to the user, transmission of the geographical position of the mobile phone to the location server 80. The location information is transmitted to the location server only if the user gives the authorisation.

Alternatively, the user can select a second operating mode “with automatic location” of the mobile phone 10. In this case, the mobile phone 10 does not execute the first step and does not display the window. The location information is transmitted automatically by the mobile phone 10 to the location server 80.

FIG. 4 illustrates a second possible embodiment of the connection method.

In this second embodiment, the cellular mobile phone 10 is equipped with a Global Positioning System (GPS) receiver so that the mobile terminal 10 is adapted of determining the coordinates (X, Y) of the geographical position. In this embodiment, the mobile phone 10 transmits, to the location server 80, a connection request that contains position information that includes the geographical position coordinates (X, Y) of the mobile phone 10.

As a consequence, the location server 80 does not have to convert the position information supplied by the mobile phone 10 since this information is already in the form of coordinates that are usable by the servers 21, 22, 23.

In this second embodiment, selection of the i-Mode™ menu triggers the execution, by the browser of the mobile phone 10, of an Application Programming Interface (API) program that includes the following steps.

In a first step, the mobile phone 10 displays, on a screen 11, a window 12 (a popup window) that proposes, to the user, transmission of the geographical position of the mobile phone to one of the servers 21, 22 or 23. The servers 21, 22, 23 are servers controlled by service providers.

The window contains a message of the type: “Do you agree to communicate your geographical position?”. The user can select one of the displayed responses, namely “YES” or “NO” (FIG. 3).

In a second step, if the user selects the “YES” proposal, the mobile phone 10 determines geographical position coordinates (X, Y) of the mobile phone 10. This determination is possible when the mobile phone 10 is equipped with positioning means, such as a GPS receiver for example.

In a third step, the mobile phone 10 transmits a connection request 1 to one of the servers 21, 22 or 23.

The connection request 1 is a request of the http type that includes the URL address of a page contained on one of the servers 21, 22 or 23 as well as data identifying the geographical position (X, Y) of the mobile phone 10.

After identifying these data, the server 21 does not trigger a process for location of the mobile phone 10.

In a fourth step, the geographical position coordinates (X, Y) are processed by the server 21 in order to transmit content to the mobile phone 10 (itineraries, the nearest restaurants, cinemas, sports centres, etc.) that is dependent upon the geographical zone in which the mobile phone 10 is located.

In a fifth step, the server 21 transmits the corresponding content 5 to the mobile phone 10.

If the user selected the “NO” response during the first step, then the mobile phone 10 executes a sixth step in which the mobile phone 10 transmits a connection request 1 to one of the http servers 21, 22 or 23 that does not include the geographical position (X, Y) of the mobile phone 10.

As a result of this sixth step, the server 21 can trigger a conventional process for location of the mobile phone 10 that is identical to the process of the prior art (a paging process for example).

Incidentally, it can be arranged that the user should be able to configure the mobile phone 10 in two operating modes.

The user can select a first operating mode “with authorisation to locate” the mobile phone 10. In this case, the mobile phone 10 still executes the first step in which it displays, on a screen 11, the popup window 12 that proposes, to the user, transmission of the geographical position of the mobile phone to the content provider. The location information is transmitted to the content provider only if the user gives authorisation.

Alternatively, the user can select a second operating mode “with automatic location” of the mobile phone 10. In this case, the mobile phone 10 does not execute the first step and does not display the popup window. The location information is transmitted automatically to the content provider 21, 22 or 23.

It will be noted that it can be arranged for the mobile phone 10 to have several positioning sources, such as one of the following sources for example: Cell-id, GPS, A-GPS, Cell-id+NMR, Cell-id+TA, or Cell-id+TA+NMR. In this case, the browser of the mobile phone can be programmed to select the most appropriate positioning means (the most accurate or the quickest). In this case, the mobile phone 10 transmits, to the location server 80, information identifying the positioning source selected and the associated location information. Incidentally, the location server 80 includes means to identify the positioning source from the aforesaid information, and to deduce from the latter the geographical coordinates of the mobile phone.

In any event, the Cell-Id cell identification information will be available in the mobile phone and can be used as location information.

1. A connection method of a cellular mobile terminal (10) to a server (21, 22, 23) that is intended to deliver an assistance service which necessitates location of the terminal (10), including steps in which:
the mobile terminal (10) transmits, to the server (21, 22, 23) delivering the assistance service, a connection request (1) to the assistance service,
the mobile terminal (10) also transmits, to the server (21), useful information (4) for the server (21, 22, 23) that is intended to deliver the assistance service, with a view to transmitting, to the mobile terminal (10), content corresponding to the connection request, where the useful information (4) is determined as a function of location information contained in the mobile terminal (10), characterised in that the connection request (1) contains data that is adapted to be identified by the server (21, 22, 23), the said data indicating to the server (21, 22, 23) that the useful information will be transmitted to the server (21, 22, 23) by the mobile terminal (10).

2. The method according to any of the preceding claims, including steps in which:
the mobile terminal (10) transmits, to a location server (80), location information (2) contained in the mobile terminal,
the location server (80) converts the location information (2) into useful information (3) for the server that is intended to deliver an assistance service (21, 22, 23), and transmits the said useful information (3) to the mobile terminal (10).

3. The method according to claim 2, wherein the location information (2) is information recorded in the mobile terminal (10).

4. The method according to claim 3, wherein the location information is information that identifies a cell of a cellular mobile telephony network (100) in which the mobile terminal is located (10).

5. The method according to claim 1, wherein the mobile terminal (10) transmits, to a location server (80), a connection request that contains the useful information.

6. The method according to any of the preceding claims, wherein the useful information (3) includes geographical position coordinates of the mobile phone (10).

7. The method according to any of the preceding claims, including steps in which:
the mobile terminal (10) transmits the useful information (4) to the server that is intended to deliver the assistance service (21, 22, 23),
the server (21) processes the useful information (4), and transmits content (5) that is dependent upon the useful information (4) to the mobile phone (10).

8. The method according to claim 7, including a step in which:
the location server (80) verifies that the assistance service (21, 22, 23) is authorised to receive the content (5) that is dependent upon the useful information (4).

9. The method according to any of the preceding claims, wherein the mobile terminal (10) transmits the useful information (4) via a data channel of the mobile terminal (10).

10. The method according to any of the preceding claims, including a preliminary step in which the mobile terminal (10) displays, on a screen (11), a window (12) that proposes, to the user, the transmission of location information of the mobile terminal (10), the user being able to accept or refuse the proposal, and in which the step for transmission of the useful information (4) is executed only if the user accepts the proposal.

11. A cellular mobile terminal (10) adapted to be connected to a server delivering an assistance service (21, 22, 23) that necessitates location of the terminal, the terminal (10) including processing means that are programmed to execute the steps, in which the mobile terminal (10) transmits, to a server delivering the assistance service (21, 22, 23), a connection request (1) to the assistance service, and the mobile terminal (10) also transmits, to the server (21, 22, 23), useful information (4) for the service server (21), with a view to transmitting to the mobile terminal (10) content corresponding to the connection request (1), with the useful information (4) being determined as a function of location information contained in the mobile terminal (10), characterised in that the processing means are programmed so that the terminal transmits to the server a request containing data adapted to be identified by the server (21, 22, 23), the said data indicating to the server (21, 22, 23) that the useful information will be transmitted to the server by the mobile terminal

12. (canceled)

13. (canceled)

14. (canceled)
